(19) United States
(12) Patent Application Publication
(10) Pub. No.: US 2006/0269066 A1
(43) Pub. Date: Nov. 30, 2006

(54) System and method for converting serial data into secure data packets configured for wireless transmission in a power system

(75) Inventors: David E. Whitehead, Pullman, WA (US); Peter S. LaDow, Pullman, WA (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(73) Assignee: Schweitzer Engineering Laboratories, Inc.

(21) Appl. No.: 11/316,525

(22) Filed: Dec. 21, 2005

Related U.S. Application Data
(60) Provisional application No. 60/678,886, filed on May 6, 2005.

(51) Int. Cl. H04K 1/00

(52) U.S. Cl. 380/270

(57) ABSTRACT

Provided is a system and method for converting serial data associated with an IED into secure data packets configured for transmission during an IED maintenance session; preferably wireless transmission. The system includes a first intelligent assembly operatively coupled to the IED, and a second intelligent assembly operatively coupled to the first intelligent device via a wireless communication link. Each of the first and second intelligent assemblies includes a microcontroller adapted to apply two independent security algorithms to the serial data to form the secure data packets, and vice versa. The second intelligent assembly further includes a plurality of legacy software applications executable to enable the IED maintenance session to be conducted by an operator from a location of the second intelligent assembly. The security algorithms preferably include an AES encryption/decryption function and a HMAC authentication function.

### CROSS-REFERENCE TO RELATED APPLICATIONS

This application claims benefit under 35 U.S.C. §119(e) of U.S. Provisional Application No. 60/678,886 entitled “A System and Method for Converting Serial Data Into Secure Data Packets Configured for Wireless Transmission in a Power System”, filed on May 6, 2005, naming Dave Whitehead and Peter LaDow as inventors, the complete disclosure thereof being incorporated by reference.

### BACKGROUND OF THE INVENTION

The present invention generally relates to power system protection, and more specifically, to a system and method for converting serial data into secure data packets configured for wireless transmission (e.g., IEEE 802.11b) in a power system.

Electric utility systems or power systems are designed to generate, transmit and distribute electrical energy to loads. In order to accomplish this, power systems generally include a variety of power system elements such as electrical generators, electrical motors, power transformers, power transmission lines, buses and capacitors, to name a few. As a result, power systems must also include intelligent electronic devices (IEDs) such as programmable logic controllers (PLCs), remote terminal units (RTUs), industrial computers, and protective devices and associated procedures, to name a few.

In general, protective devices and procedures act to isolate some power system element(s) from the remainder of the power system upon detection of the abnormal condition or a fault in, or related to, the protected power system element(s). More specifically, different protective relays utilizing a variety of protective schemes (e.g., differential current comparisons, magnitude comparisons, frequency sensing), are designed to protect the variety of power system elements. For example, using power system voltage and current information derived via secondary current and voltage signals, a directional overcurrent relay is designed to provide directional protection against faults occurring in a line protection zone (e.g., protected transmission, sub-transmission or distribution lines). That is, for power systems having several generation sources or looped or non-radial line configurations, the overcurrent relay is directionally sensitive to operate when a ground fault occurs only on its protected line (e.g., an A-phase-to-ground fault).

When a fault does occur and its direction is determined, the directional overcurrent relay issues a tripping signal to an associated power circuit breaker(s) or recloser causing it to open and isolate the faulted overhead transmission line from the remainder of the power system. Automatic re-energization of the power circuit breaker(s) or recloser may then be initiated by the relay or a recloser control after a pre-selected time, thereby restoring the power to the previously faulted overhead transmission line.

An IED such as a directional overcurrent relay is often pole-mounted in a weather-resistant enclosure, high above the ground. Other IEDs are often enclosed in a substation. As a result, maintenance and test activities such as adjusting relay settings, setting configuration files, collecting status and event reports have traditionally been burdensome for the engineers conducting them, especially if the engineers are conducting the activities in dangerous environments or during inclement weather conditions.

In the past, the engineer was required to physically access the weather-resistant enclosure, open the enclosure door and access the necessary serial port in order to conduct the maintenance and test activities. In addition exposing the components inside the enclosure to the environment, the engineers themselves were often exposed to dangerous conditions.

Recently, wireless links such as Wireless Fidelity or WiFi links (i.e., IEEE 802.11b) have been used during the maintenance and test activities to download and upload data between an engineer's computer and the relay (and recloser control), thereby permitting the engineer to conduct the activities from the relative comfort of a vehicle parked near the relay. While providing a useable link for downloading and uploading data, wireless links such as WiFi links are not cryptographically secure. This, despite enabling existing wired equivalency privacy (WEP) (i.e., encryption algorithm used to provide a privacy equivalent to that of a wired LAN) currently available when implementing a WiFi link. Thus, most relay maintenance and test data (“relay data”) being uploaded to the relay (e.g., relay settings) and downloaded from the relay (e.g., relay operation data) via the WiFi link may be detected by malicious intruders.

### SUMMARY OF THE INVENTION

In accordance with the invention, provided is a system and method for converting serial data into secure data packets, preferably configured for wireless transmission (e.g., IEEE 802.11b) in a power system.

Provided is a system for converting serial data associated with an intelligent electronic device (IED), for example, a protective relay of a power system, into secure data packets configured for wireless transmission during an IED maintenance session. The system includes a first intelligent assembly operatively coupled to the IED. The first intelligent assembly includes a first I/O module and a first microcontroller operatively coupled to the first I/O module, and is adapted to apply at least two independent security algorithms to the serial data to form the secure data packets and to the secure data packets to form the serial data. The system also includes a second intelligent assembly. The second intelligent assembly includes a plurality of legacy software applications, a second I/O module and a second microcontroller operatively coupled to the second I/O module and the plurality of legacy software applications. The second intelligent assembly is adapted to apply the two independent security algorithms to the serial data to form the secure data packets and to the secure data packets to form the serial data. The plurality of legacy software applications are executable by the second microcontroller to enable the IED maintenance session to be conducted by an operator from a location of the second intelligent device upon establishment of a virtual serial port.

Provided is another system for converting serial data associated with an IED, for example, a protective relay of a power system, into secure data packets configured for wireless transmission during an IED maintenance session. The IED includes a first serial port. The system includes an encrypting/decrypting transceiver and an intelligent portable device. The encrypting/decrypting transceiver includes a second serial port adapted to enable a serial data exchange with the first serial port, a first microcontroller operatively coupled to the second serial port and adapted to apply at least two independent security algorithms to the serial data to form the secure data packets and to the secure data packets to form the serial data, and a first wireless module operatively coupled to the first microcontroller and adapted to enable wireless transmission and receipt of the secure data packets over a wireless communication link. The intelligent portable device includes a second wireless module adapted enable to wireless transmission and receipt of the secure data packets over the wireless communication link, a second microcontroller operatively coupled to the second wireless port/module and adapted to apply the at least two independent security algorithms to the serial data to form the secure data packets and to the secure data packets to form the serial data, and a plurality of legacy software applications executable by the second microcontroller to enable the IED maintenance session to be conducted by an operator from a location of the intelligent portable device upon establishment of a virtual serial port. The virtual serial port enables the serial data exchange between the plurality of legacy software applications and the IED during the IED maintenance session.

Provided is a method for converting serial data associated with an IED into secure data packets configured for transmission between an encrypting/decrypting transceiver and a portable intelligent device during an IED maintenance session. The encrypting/decrypting transceiver is operatively coupled to the IED and includes a first microcontroller. The portable intelligent device includes a second microcontroller. The method includes establishing a communication link between the encrypting/decrypting transceiver and the portable intelligent device, and executing a session authentication frame exchange between the encrypting/decrypting transceiver and the portable intelligent device to verify the portable intelligent device. The session authentication frame exchange includes application of at least two independent security algorithms. The method also includes, upon successful execution of the session authentication frame exchange, executing a serial data exchange during the IED maintenance session between a plurality of legacy software applications of the portable intelligent device and the IED. The serial data exchange includes application of the two independent security algorithms.

Provided is another method for converting serial data associated with an IED into secure data packets configured for transmission between an encrypting/decrypting transceiver and a portable intelligent device during an IED maintenance session. The encrypting/decrypting transceiver is operatively coupled to the IED and includes a first microcontroller. The portable intelligent device includes a second microcontroller. The method includes establishing a wireless communication link between the encrypting/decrypting transceiver and the portable intelligent device, and executing a session authentication frame exchange between the encrypting/decrypting transceiver and the portable intelligent device to verify the portable intelligent device. The session authentication frame exchange includes application of an Advance Encryption Standard (AES) encryption/decryption function and a Hashed Message Authentication Code (HMAC) authentication function. The method also includes, upon successful execution of the session authentication frame exchange, executing a serial data exchange during the IED maintenance session between a plurality of legacy software applications of the portable intelligent device and the IED. The serial data exchange includes application of the AES encryption/decryption function and the HMAC authentication function.

It should be understood that the present invention includes a number of different aspects or features which may have utility alone and/or in combination with other aspects or features. Accordingly, this summary is not exhaustive identification of each such aspect or feature that is now or may hereafter be claimed, but represents an overview of certain aspects of the present invention to assist in understanding the more detailed description that follows. The scope of the invention is not limited to the specific embodiments described below, but is set forth in the claims now or hereafter filed.

### BRIEF DESCRIPTION OF THE DRAWINGS

FIG. 1 is a single line schematic diagram of a power system that may be utilized in a typical wide area.

FIG. 2 is a block diagram of a system for converting serial relay data to secure data packets configured for transmission during an IED maintenance session, according to an embodiment of the invention.

FIG. 3 is a functional block diagram of the PC of the system of FIG. 2.

FIG. 4 is a functional block diagram of the encrypting/decrypting transceiver of the system of FIG. 2.

FIG. 5 is a flowchart of a method for performing a session authentication dialog to establish a relay maintenance session, according to an embodiment of the invention.

FIG. 6 is a functional block diagram of a first portion of the AES/HMAC security function, according to an embodiment of the invention.

FIG. 7 is a functional block diagram of a second portion of the AES/HMAC security function, according to an embodiment of the invention.

### DETAILED DESCRIPTION OF THE INVENTION

For ease of discussion, aspects of the invention can be more fully understood via discussing a pole-mounted recloser control configured to protect an overhead transmission line, where the recloser control is operatively coupled to both the overhead transmission line (via current and voltage transformers) and a recloser, and includes a directional overcurrent relay with a recloser control element, a battery(s) and a power supply. It should be noted however, that the invention is applicable to any IED having a microcontroller including a microprocessor, a serial port and a memory, or an FPGA or equivalent. Further, although discussed in terms of a wireless fidelity (WiFi) link, the invention is applicable to any wireline (e.g., Ethernet) or wireless link such as, for example enhanced Bluetooth (IEEE 802.15.x) or WiMax (IEEE 802.16), where data authentication and security is a high priority.

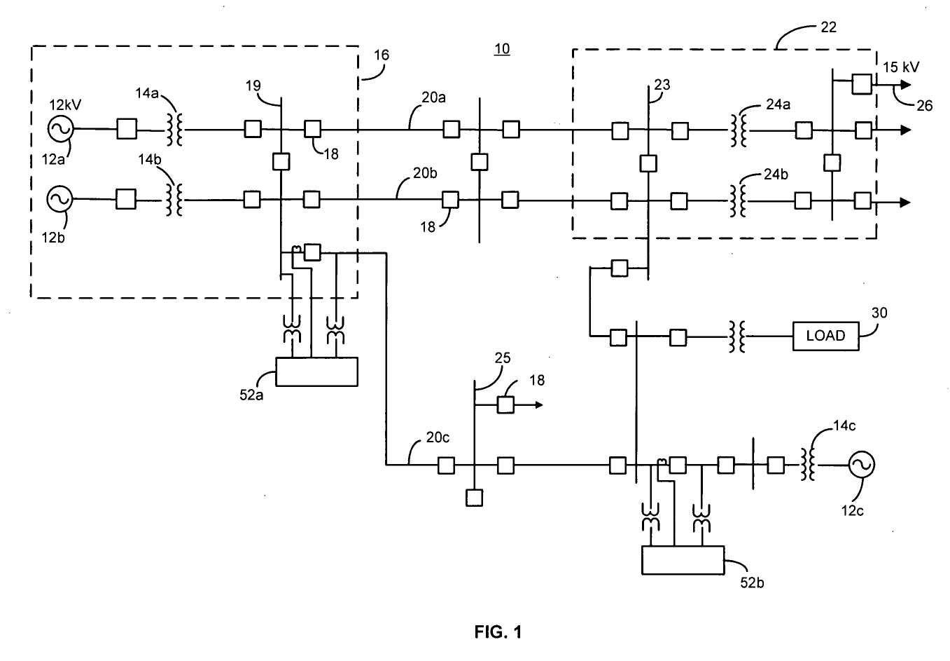

FIG. 1 is a single line schematic diagram of a power system 10 that may be utilized in a typical wide area. As illustrated in FIG. 1, the power system 10 includes, among other things, three generators 12a, 12b and 12c, configured to generate three-phase sinusoidal waveforms such as 12 kV sinusoidal waveforms, three step-up power transformers 14a, 14b and 14c, configured to increase the generated waveforms to a higher voltage sinusoidal waveforms such as 138 kV sinusoidal waveforms and a number of circuit breakers 18. The step-up power transformers 14a, 14b, 14c operate to provide the higher voltage sinusoidal waveforms to a number of long distance transmission lines such as the transmission lines 20a, 20b and 20c. In an embodiment, a first substation 16 may be defined to include the two generators 12a and 12b, the two step-up power transformers 14a and 14b and associated circuit breakers 18, all interconnected via a first bus 19. A second substation 22 may be defined to include two step-down power transformers 24a and 24b configured to transform the higher voltage sinusoidal waveforms to lower voltage sinusoidal waveforms (e.g., 15 kV) suitable for distribution via one or more distribution lines.

As previously mentioned the power system 10 includes protective devices and associated procedures to protect the power system elements from faults or other abnormal conditions. For example, a protective device 52a is operatively coupled to the transmission line 20c and is configured as a recloser control (e.g., includes a directional overcurrent relay with a recloser control element, a battery(s) and a power supply) that utilizes power system voltage and current information to determine a fault and its direction in the transmission line 20c. Another protective device 52b is similarly configurable and operable.

Once installed in the power system, such protective devices 52a and 52b require periodic maintenance and testing by an engineer. For those protective devices (or other IEDs) not easily accessible due to their physical placement, wired or wireless links may be available to facilitate periodic data collection, diagnostic checking and testing. Such wired or wireless links however, are generally insecure against malicious intruders.

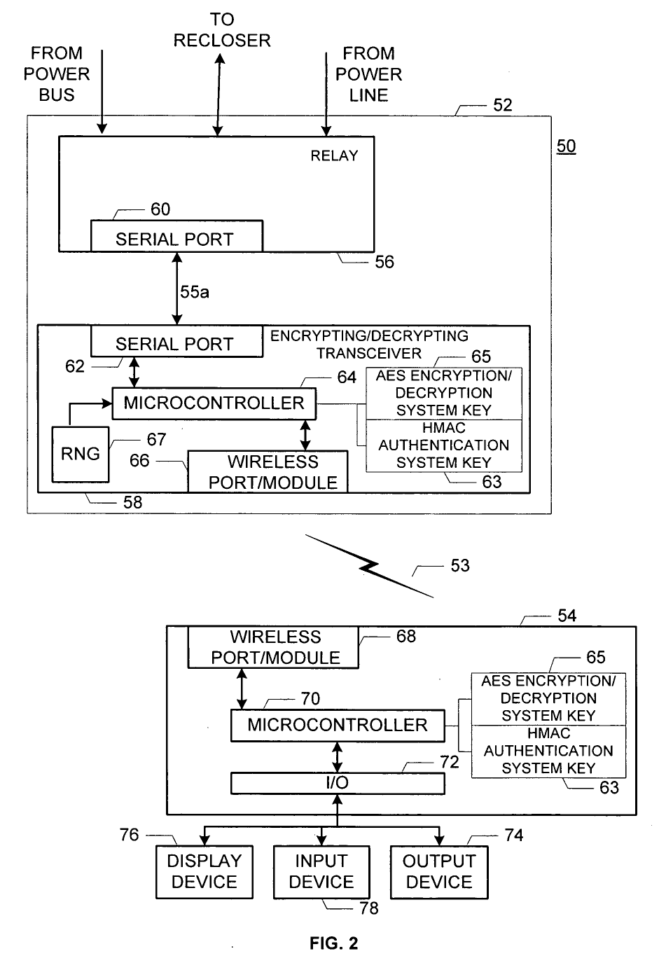

FIG. 2 is a block diagram of a system 50 for converting serial relay data into secure data (packets) configured for transmission during a relay maintenance session, according to an embodiment of the invention. As illustrated, the system 50 includes the protective device 52a (hereinafter referred to the protective device 52) of FIG. 1, adapted to communicate with a maintenance personal computer (PC) 54 via a communication link 53. The relay maintenance session is preferably conducted by an operator from a location of the PC 54, and includes downloading relay test and maintenance data (e.g., relay settings) from the PC 54 to the relay 56 and/or uploading relay test and maintenance data (e.g., request for metering data) from the relay 56 to the PC 54. Although referred to herein as the PC 54, the maintenance personal computer may be one of any number of intelligent portable devices suitably configured with a microcontroller, transmitter and receiver (e.g., a PDA), capable of transmitting data to and receiving data from the protective device 52. Further, although discussed in terms of a WiFi wireless link, the communication link 53 established between the PC 54 and the protective device 52 may be any type of suitable wireless such as such as microwave, IR, etc., or any type of suitable wireline link such as such as Ethernet, fiber channel, optical fiber, LAN, WAN etc.

Referring to FIG. 2, the protective device 52 includes a relay 56 having a first serial port 60, an encrypting/decrypting transceiver 58 having a second serial port 62, and a number of batteries and a power supply (not separately illustrated). For purposes of discussion, the protective device 52 is configured to include a relay 56 with a recloser control element; however it may be any suitably configured IED. The relay 56 and the encrypting/decrypting transceiver 58 are adapted to exchange relay data via the first and second serial ports respectively, where each of the serial ports is configured to support sequential, one bit-at-a-time transmission, or serial transmission/reception, via one of a number of protocol standards (e.g., a RS-232C interface standard using a universal asynchronous receiver/transmitter interface) to a serial port of another device.

In general, during operation of the relay 56, secondary current and voltage waveforms received via respective step-down current and voltage transformers (not separately illustrated) coupling the relay 56 to the transmission line 20c are filtered, multiplexed, sampled and digitized to form corresponding digitized current and voltage signals. The corresponding digitized current and voltage signals are digitally filtered to eliminate DC and unwanted frequency components, and are then processed by the relay 56 to extract phasors representative of their corresponding primary current and voltage waveforms. Various calculations using the phasors are performed to determine the condition of the transmission line 20c.

In addition to the second serial port 62, the encrypting/decrypting transceiver 58 also includes a first microcontroller 64 operatively coupled to the second serial port 62, and a random number generator (RNG) 67 operatively coupled to the first microcontroller 64. The RNG 67 is configured to generate random bits that are utilized to create a 128-bit AES encryption/decryption session key and a 128-bit HMAC session key (discussed below) for use during a relay maintenance session between the protective device 52 and the PC 54. The encrypting/decrypting transceiver 58 also includes an I/O module, in this example, a first wireless port/module 66, operatively coupled to the first microcontroller 64, and configured to enable wireless transmission and reception of encrypted relay data. If communicating via a wireline link to the PC 54 however, another suitable I/O port or communication module, operatively coupled to the first microcontroller 64, may be utilized rather than the first wireless port/module 66.

In general, the first microcontroller 64 includes a microprocessor, or CPU, and a memory (not separately illustrated) operatively coupled to the microprocessor where the memory may include a program memory (e.g., a Flash EPROM) and a parameter memory (e.g., an RAM). As will be appreciated by those skilled in the art, other suitable microcontroller configurations (or FPGA configurations) may be utilized.

Referring again to FIG. 2, the PC 54 includes a second microcontroller 70 and another I/O module, in this example, a second wireless port/module 68 operatively coupled to the second microcontroller 70, both configured and operable as described above. If communicating via a wireline link to the protective device 52 however, another suitable I/O port or communication module, operatively coupled to the second microcontroller 70, may be utilized in place of the second wireless port/module 68.

The PC 54 may also include one or more operator input devices 78 which may include a keyboard, a scanner, a mouse, a touch pad, and/or an audio input device and/or a video input device, a display device 76 configured in any suitable manner, and an output device 26, such as a printer, a fax/modem, etc., all operatively coupled to the second microcontroller 70 via an I/O circuit 72.

Although not separately illustrated, each of the first and second wireless port/modules 66 and 68 may include their own microcontroller-based platform adapted to cause a number of portions or routines of one or more computer programs to be executed to enable a wired equivalency privacy (WEP) encryption/decryption function and wireless transmission/receipt.

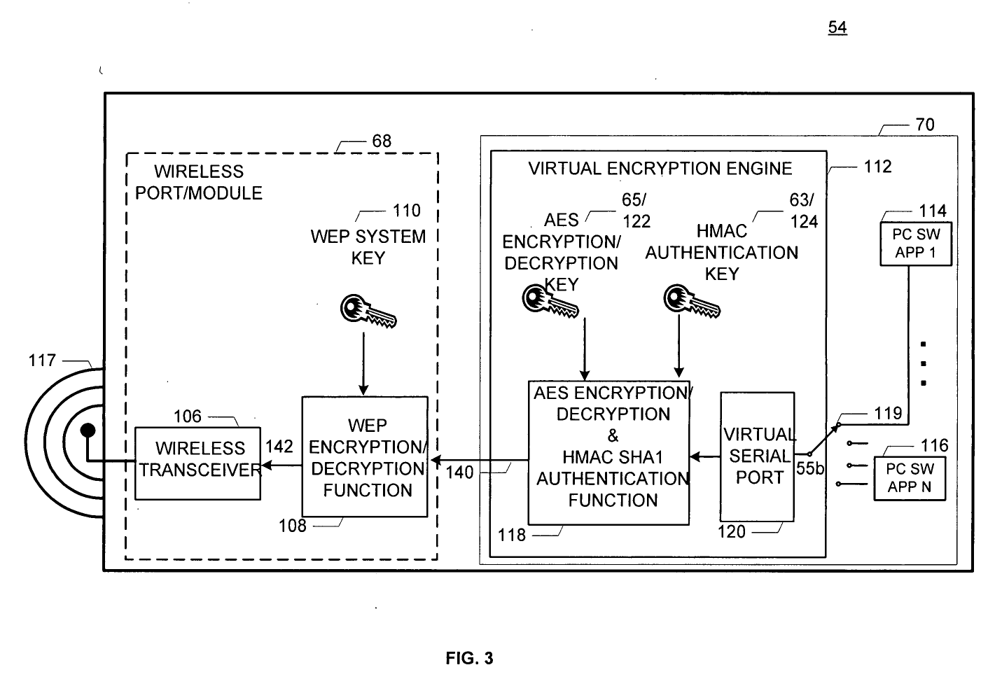

As discussed in connection with FIGS. 3-7 below, among other things the encrypting/decrypting transceiver 58 utilizes at least two independent security algorithms (1) applied to the serial relay data to form the secure data packets and (2) applied to the secure data packets to form the serial relay data. As is known, authentication is used to verify message integrity (e.g., to verify that the message has not been altered), and encryption is used to conceal the contents of the message.

The two independent levels of security are preferably provided by a 128-bit AES encryption/decryption function with a hash function based keyed-hash message authentication code. A 104-bit WEP encryption/decryption function may also be utilized in addition to the two independent security algorithms. It is contemplated however, that the two independent levels of security may be provided by other encryption/decryption functions such as a Wi-Fi protected access (WPA) function and a triple-Data Encryption Standard (DES) encryption/decryption function, to name a few.

Prior to providing secure relay data capability, initialization of the encrypting/decrypting transceiver 58 and the PC 54 is performed. Initialization includes inserting, via respective serial ports, an HMAC authentication system key 63 and an AES encryption/decryption system key 65 into the encrypting/decrypting transceiver 58 and the PC 54. Not to be confused with an HMAC authentication session key generated during a session authentication dialog, or frame exchange, for later use during the relay maintenance session (see, FIG. 3), the 128-bit HMAC authentication system key 63 is used in conjunction with its associated HMAC SHA-1 function to provide authentication of blocks or frames of relay data assembled into data packets. Similarly, not to be confused with an AES encryption/decryption session key generated during the session authentication dialog for later use during the relay maintenance session, the 128-bit AES encryption/decryption system key 65 is used in conjunction with its associated AES function to scramble, or encrypt, and unscramble, or decrypt, frames of relay data during the session authentication dialog. While not ensuring repudiation as a digital signature would, implementation of the HMAC ensures that relay data has not been corrupted in transit between the protective device 52 and another device such as the PC 54.

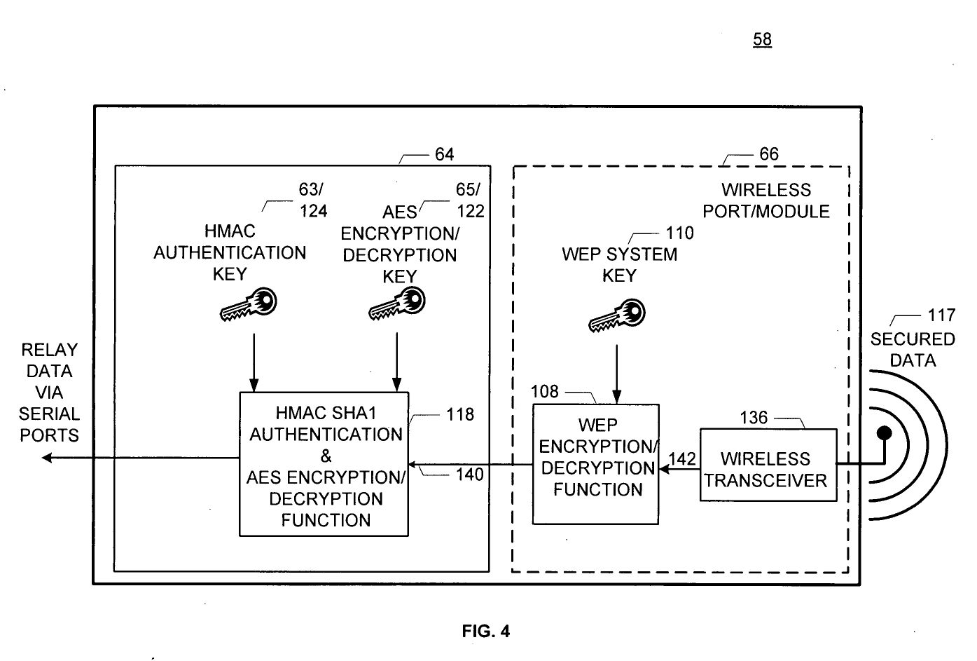

Initialization of the encrypting/decrypting transceiver 58 and the PC 54 further includes initializing a WEP system key to enable the WEP encryption/decryption function. As described in connection with FIGS. 3 and 4, the WEP system key 110 is included as an option with the first and second wireless port modules 66, 68. Initialization of the encrypting/decrypting transceiver 58 also requires (1) initializing the AES encryption/decryption system key 65 and the HMAC authentication system key 63, (2) programming the encrypting/decrypting transceiver 58 with a service set identifier (i.e., an SSID is a 1-32 byte alphanumerical name given to the encrypting/decrypting transceiver 58 and the PC 54), an IP address and a session password, and (3) programming the PC 54 with an SSID and an IP address.

Generally the WEP encryption and decryption function utilizes a symmetric RC-4 encryption/decryption algorithm with a 40-bit (or 104-bit) WEP system key. When WEP is enabled, both the encrypting/decrypting transceiver 58 and the PC 54 are assigned the WEP system key 110. Once initialized, the WEP system key 110 is used to encrypt, or scramble, the data contents of a relay data packet at the transmitting end. An integrity check and decryption of the data packets, via the WEP system key, is performed at the receiving end to ensure that the relay data was not modified in transit.

As is known, the HMAC is implemented by utilizing an underlying iterative cryptographic hash function over data (or the message), and a shared key. As illustrated in FIGS. 3-7, the iterative cryptographic hash function is a secure hash algorithm 1 (SHA-1) hash function, however other secure hash functions may be utilized such as, for example, a MD5 algorithm.

As mentioned above, maintenance and test activities conducted during an IED maintenance session traditionally required the engineer to gain entry to the relay 56, often pole-mounted in an enclosure high above the ground, to access the desired relay data via a serial port. With the advent of wireless links such as those provided via 802.11 protocols, engineers can now access the relay data without gaining physical access to the relay 56. While providing a useable link for downloading and uploading data however, wireless links such as WiFi links are typically not secure, even with the WEP encryption/decryption function enabled. Accordingly, most relay data being uploaded and downloaded via the wireless link is susceptible to detection by malicious intruders.

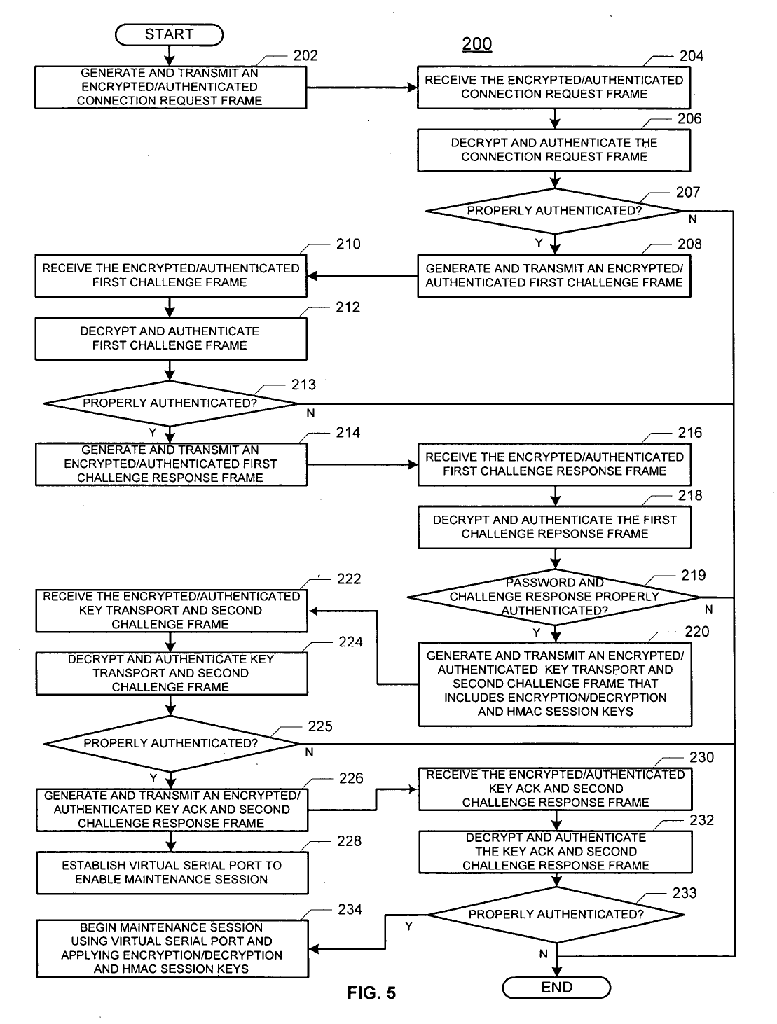

FIG. 3 is a detailed functional block diagram of the PC 54, according to an embodiment of the invention. Subsequent to successfully completing a session authentication dialog (see, FIG. 5) with the encrypting/decrypting transceiver 58, the PC 54 can receive and transmit secure data packets during the relay maintenance session. The secure data packets containing relay data are received and transmitted via a first wireless transceiver 106 and are utilized by legacy software applications 114 through 116 when received via a virtual serial port 120. The legacy software applications 114-116 represent engineering software tools or programs that may be used during the relay maintenance session for data collection, diagnostic checking, etc.

The virtual serial port 120 is established only after successfully completing the session authentication dialog. Establishment of the virtual serial port 120 allows relay data (e.g., request for metering data, request for fault location data, relay pickup settings) from the relay 56 to be provided to the legacy software applications 114-116 to facilitate determinations about the state of the relay 56. Establishment of the virtual serial port 120 also allows relay data (e.g., relay settings) from the legacy software applications 114-116 to be provided to the relay 56, according to the embodiment of the invention.

As noted in connection with FIG. 2, the PC 54 includes the second wireless port/module 68 and the second microcontroller 70. Referring now to FIG. 3, the second wireless port/module 68 includes the first wireless transceiver 106, a WEP encryption/decryption function 108, and the WEP system key 110. Although provided via the microcontroller-based platform of the second wireless port/module 68, it is contemplated that the WEP encryption/decryption function 108 may be alternatively provided by the second microcontroller 70. Further, although depicted in FIGS. 3-4 and 6-7, enablement of the WEP encryption/decryption function 108 is optional.

The second microcontroller 70 includes a virtual encryption engine 112, and the legacy software applications 114-116. A virtual switch 119 is included to allow the legacy software applications 114-116 to select the virtual serial port 120 for “serial” transmission of unencrypted (serialized) relay data. It should be noted however, that the virtual serial port is not established until successful completion of the session authentication dialog between the PC 54 and the encryption/decryption transceiver 58. The virtual encryption engine 112 includes the AES encryption/decryption and HMAC SHA-1 authentication function 118 (“AES/HMAC security function 118”), the associated AES encryption/decryption system key 65, the HMAC authentication system key 63 (see, FIG. 2) and the virtual serial port 120. While described in terms of functional blocks, it should be understood by those skilled in the art that the second microcontroller 70, executing logic or software programs or routines stored in its memory (or provided via an external means such as a CD), provides the AES/HMAC security function 118, the virtual serial port 120, the virtual switch 119, etc.

Although discussed in terms of receiving and utilizing relay data, it will be appreciated by one skilled in the art that the PC 54 is also adapted to convert relay data generated via the legacy software applications 114-116 into secure data packets, and then transmit the secure data packets via the communication link 53 to the protective device 52.

FIG. 4 is a detailed functional block diagram of the encrypting/decrypting transceiver 58 of FIG. 2. As noted above, the encrypting/decrypting transceiver 58 is configured to receive secure data packets, and then provide the associated relay data to the relay 56 via its second serial port 62. The encrypting/decrypting transceiver 58 is also configured to convert relay data received from the relay 56 into secure data packets, and transmit the secure data packets to the PC 54, according to an embodiment of the invention.

Referring to FIG. 4, the encrypting/decrypting transceiver 58 includes the first microcontroller 64 and the first wireless port/module 66 having a second wireless transceiver 136, the WEP encryption/decryption function 108, and the WEP system key 110. Although provided via the first wireless port/module 66, it is contemplated that the encryption/decryption function 108 may alternatively be provided by the first microcontroller 64.

The first microcontroller 64 includes the AES/HMAC security function 118, the associated AES encryption/decryption system key 65 and the associated HMAC authentication system key 63 (see, FIG. 2). While described in terms of functional blocks, it should be understood by those skilled in the art that the first microcontroller 64, executing logic or software programs or routines stored in the memory of the first microcontroller 64 (or provided via an external means such as a CD), provides such functionality.

FIG. 5 is a flowchart of a method 200 for performing a session authentication dialog to establish a relay maintenance session where serial relay data is converted into secure data packets for transmission, according to an embodiment of the invention. Although executed by the first and second microcontroller 64, 70, it is contemplated that the method 200 may be executed by an included FPGA or the like, and/or may be executed by any IED coupled to the encrypting/decrypting transceiver 58 and/or PC 54, respectively.

In summary, the method 200 begins with the session authentication dialog between the second microcontroller 70 of the PC 54 and the first microcontroller 64 of the encrypting/decrypting transceiver 58. Successful execution of session authentication dialog establishes or verifies that the PC 54 is permitted to exchange relay data with the protective device 52. The session authentication dialog preferably consists of an exchange of encrypted and authenticated frames (via the AES/HMAC security function 118, the associated AES encryption/decryption system key 65 and associated HMAC authentication system key 63). For example, five frames exchanged may include a connection request frame from the PC 54, a first challenge frame from the encrypting/decrypting device 58, a first challenge response frame from the PC 54, a key transport and second challenge frame from the encrypting/decrypting device 58, and a key ack and second challenge response frame from the PC 54.

Upon successful completion of the session authentication dialog, the virtual serial port 120 is established in the PC 54. This allows the relay data to be uploaded and downloaded as secure data packets 117 transmitted between the PC 54 and the protective device 52 via the communication link 53. AES encryption/decryption and HMAC authentication session keys 122, 124, resulting from the session authentication dialog are used for subsequent encryption and authentication by AES/HMAC security function 118 during the relay maintenance session. The relay data contained in the secure data packets from the protective device 52 is initially passed as unencrypted relay data 55a from the relay 56 to the encrypting/decrypting transceiver 58 via the first and second serial ports 60, 62. Similarly, the relay data contained in the secure data packets from the PC 54 is received via the virtual serial port 120 as unencrypted relay data 55b from the legacy software applications 114-116.

More specifically, the method 200 begins when the PC 54 requests establishment of a relay maintenance session with the protective device 52 via generation and transmission of an encrypted and authenticated connection request frame (step 202). In an embodiment, the PC 54 requests establishment of the relay maintenance session subsequent to receipt of an operator request via the input device 78 (see, FIG. 2). Referring also to FIG. 3, the connection request frame is first generated and then encrypted and authenticated by the second microcontroller 70 via the AES/HMAC security function 118 using the AES encryption/decryption system key 65 and the HMAC authentication system key 63. It is further encrypted via the WEP function 108 using the WEP system key 110 to form the encrypted and authenticated connection request frame, and then transmitted via the first wireless transceiver 106 to the protective device 52.

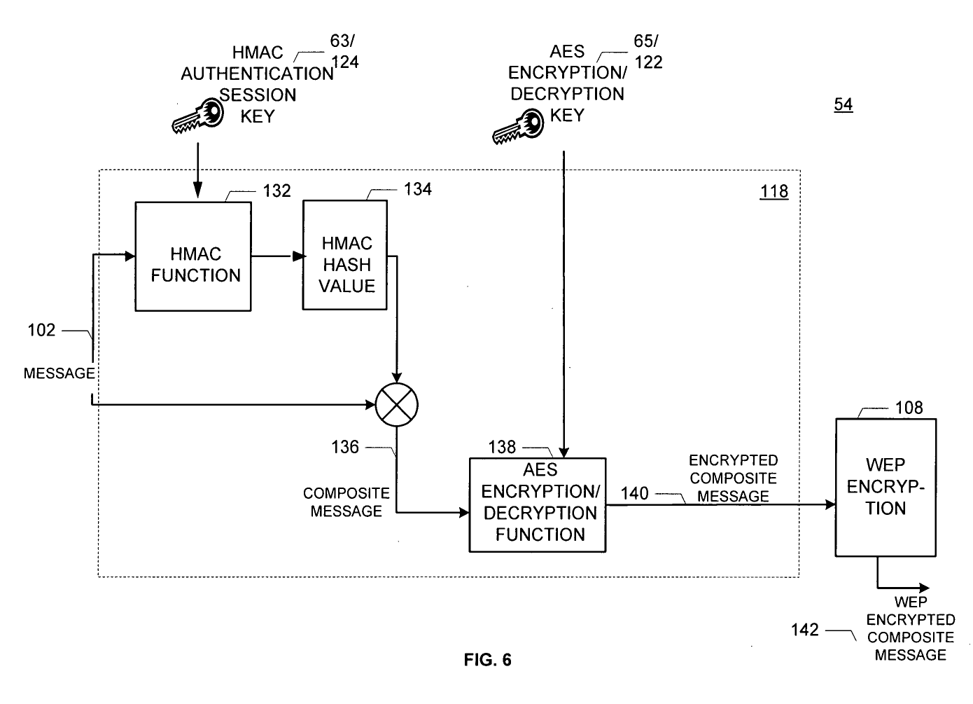

FIG. 6 is a functional block diagram of a first portion of the AES/HMAC security function 118, according to an embodiment of the invention. While discussed as a first, or encryption, portion, it should be understood that the AES/HMAC security function 118 of the second microcontroller 70 also includes a second, or decrypting, portion (discussed below). In the illustrated example of FIG. 6, the PC 54 executing the AES/HMAC security function 118 utilizes the AES encryption/decryption system key 65 and the HMAC authentication system key 63 to encrypt and authenticate the connection request frame during the session authentication dialog. Upon successful completion of the session authentication dialog, an AES encryption/decryption session key 122 and an HMAC authentication session key 124 generated during the session authentication dialog replaces the AES encryption/decryption system key 65 and the HMAC authentication system key 63 for subsequent encryption/decryption and authentication of the relay data. As a result of the two new session keys being generated during each session authentication dialog, the amount of relay data protected by any single session key is limited to that relay maintenance session, thereby minimizing the possibility of intruder acquisition of the keys.

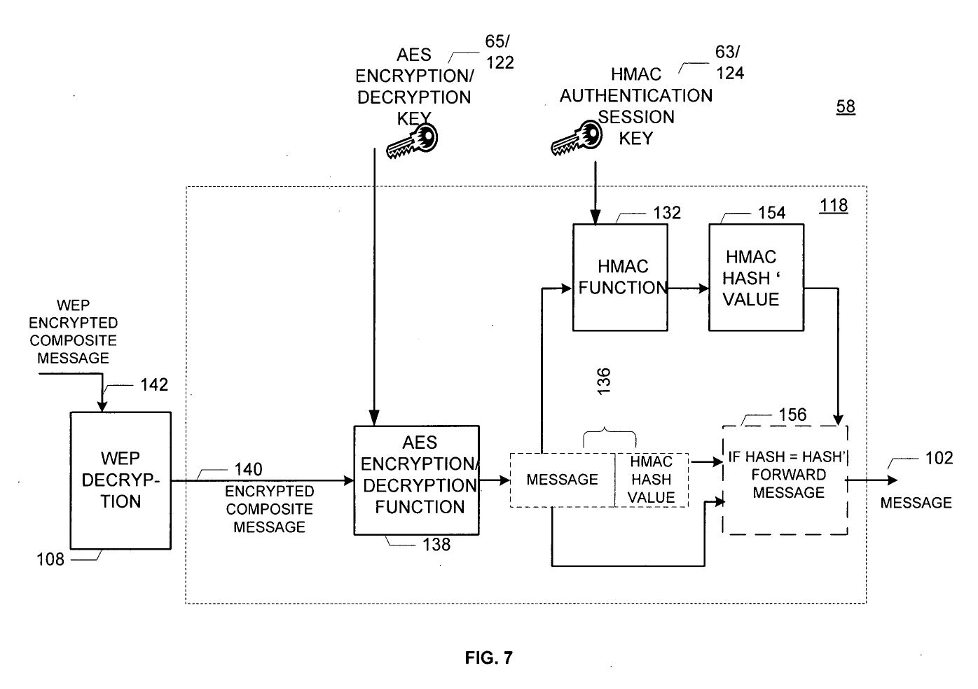

Referring to FIG. 6, upon an indication (e.g., a command from the operator, received via the input device 78 of FIG. 2), the connection request frame is generated by the second microcontroller 70. As discussed below, the five frames of the session authentication dialog are functionally generated by either the first or second microcontrollers 64, 70. It should be noted however, that after successful completion of the session authentication dialog, relay data may be passed via the virtual serial port 120 as a result of execution of one of the legacy software applications 114-116 by the second microcontroller 70. Relay data may also be passed via the first and second serial ports 60, 62 of the protective device 52. For ease of discussion regarding operation of the AES/HMAC security function 118 (FIGS. 6 and 7), the connection request frame of the session authentication dialog functionally generated by the second microcontroller 70 is referred to as a “message 102”, it being understood that the four remaining frames of the session authentication dialog and the subsequent relay data are similarly encrypted.

Using the HMAC authentication system key 63 and the message 102 (e.g., the generated connection request frame), an HMAC function 132 generates a 160-bit, fixed length HMAC hash value 134. The HMAC hash value 134 represents a condensed key-dependant fingerprint or signature of the message 102. The HMAC hash value 134 is then appended to the message 102 to form a composite message 136.

Next, the composite message 136 is encrypted by an AES encryption/decryption function 138 via the 128-bit AES encryption/decryption system key 65. As a result, the composite message 136 is encrypted to form an encrypted composite message 140 that is a function of the composite message 136 and the AES encryption/decryption system key 65. The encrypted composite message 140 is then forwarded to the second wireless port/module 68 for WEP encryption to form a WEP encrypted composite message 142 (see, FIG. 3), and transmitted to the protective device 52 as described above (step 202).

For example, after generation and application of the HMAC hash value 134 to the connection request frame, it is AES encrypted to form an encrypted composite connection request and then WEP encrypted via the WEP encryption/decryption function 108 to form the encrypted and authenticated connection request frame suitable for transmission via the first wireless transceiver 106.

Referring again to FIGS. 4 and 5, when received by the second wireless transceiver 136 of the encrypting/decrypting transceiver 58 (step 204), the encrypted and authenticated connection request frame is decrypted via the WEP function 108 using the WEP system key 110 and then further decrypted and authenticated via the AES/HMAC security function 118 using the AES encryption/decryption system key 65 and the HMAC authentication system key 63 (step 206).

For example, FIG. 7 is a functional block diagram of a second portion of the AES/HMAC security function 118, according to an embodiment of the invention. While discussed as a second, or decryption, portion, it should be understood that the AES/HMAC security function 118 of the first microcontroller 64 also includes the first, or encrypting, portion (discussed above). In the illustrated example of FIG. 7, the encrypting/decrypting transceiver 58 executing the AES/HMAC security function 118 utilizes the AES encryption/decryption system key 65 and the HMAC authentication system key 63 to decrypt and authenticate the connection request frame during the session authentication dialog. Referring to FIG. 7, upon receipt by the encrypting/decrypting transceiver 58, the WEP encrypted composite message 142 is WEP decrypted by the WEP encryption/decryption function 108 to form the encrypted composite message 140. Next, the encrypted composite message 140 is further decrypted by the AES encryption/decryption function 138 through the use of the AES encryption/decryption system key 65. As a result, the encrypted composite message 140 is decrypted to form the composite message 136. The composite message 136 should include the original message 102 and the HMAC hash value 132.

Next, using the HMAC authentication system key 63, the HMAC function 132 is applied to the composite message 136 to derive an HMAC hash prime value 154. If the HMAC hash prime value 154 matches the original HMAC hash value 134, the HMAC hash value is removed from the composite message 136 and the resulting message 102 is accepted as valid by the first microcontroller 64. If the resulting message 102 is not valid, the session authentication dialog is terminated.

Referring again to FIG. 5, if the connection request frame is properly authenticated (step 207), the first microcontroller 64 causes the RNG 58 to generate a large, random challenge value, or first random challenge value for inclusion in a first challenge frame. The first random challenge value is encrypted and authenticated via the AES/HMAC security function 118 using the AES encryption/decryption system key 65 and the HMAC authentication system key 63. It is further encrypted via the WEP function 108 using the WEP system key 110 to form the first challenge frame, and then transmitted via the wireless transceiver 106 of the encrypting/decrypting transceiver 58 (step 208).

When received by the wireless transceiver 106 of the PC 54 via the wireless port/module 68 (step 210), the first challenge frame is decrypted via the WEP function 108 using the WEP system key 110 and further decrypted and finally authenticated via the AES/HMAC security function 118 using the AES encryption/decryption system key 65 and the HMAC authentication system key 63 (step 212).

If the first random challenge value of the first challenge frame is authenticated (step 213), a password previously entered by the operator via the input device 78 of the PC 54 is combined with the first random challenge value to form a first challenge response frame. The first challenge response frame is then encrypted and authenticated via the AES/HMAC security function 118 using the AES encryption/decryption system key 65 and the HMAC authentication system key 63. It is further encrypted via the WEP function 108 using the WEP system key 110 to form the encrypted and authenticated first challenge response frame, and then transmitted to the encrypting/decrypting transceiver 58 of the protective device 52 (step 214).

When received by the wireless transceiver 106 of the encrypting/decrypting transceiver 58 (step 216), the encrypted and authenticated first challenge response frame is decrypted via the WEP function 108 using the WEP system key 110 and further decrypted and finally authenticated via the AES/HMAC security function 118 using the AES encryption/decryption system key 65 and the HMAC authentication system key 63 (step 218). If the password entered by the engineer and included in the first challenge response frame matches a password previously programmed into the encrypting/decrypting transceiver 58 during initialization and the first random challenge value extracted from the first challenge response frame matches the first random challenge value caused to be previously generated by the first microcontroller 64 (step 219), then the microcontroller 64 generates another large random challenge value, or (1) a second random challenge value, (2) an AES encryption/decryption session key 122, and (3) a HMAC authentication session key 124 to form a key transport and second challenge frame. Upon completion of a successful session authentication dialog, both the AES encryption/decryption session key 122 and the HMAC authentication session key 124 will be used to authenticate and encrypt/decrypt relay data subsequently transmitted during the relay maintenance session between the protective device 52 and the PC 54.

The key transport and second challenger frame is encrypted and authenticated via the AES/HMAC security function 118 using the AES encryption/decryption system key 65 and the HMAC authentication system key 63. It is further encrypted via the WEP function 108 using the WEP system key 110 to form an authenticated and encrypted key transport and second challenger frame, and then transmitted via the wireless transceiver 106 of the encrypting/decrypting transceiver 58 to the PC 54 (step 220).

When received by the wireless transceiver 106 of the PC 54 (step 222), the authenticated and encrypted key transport and second challenger frame is decrypted via the WEP function 108 using the WEP system key 110 and further decrypted and finally authenticated via the AES/HMAC SHA-1 security function 118 using the AES encryption/decryption system key 65 and the HMAC authentication system key 63 (step 224).

After extracting and authenticating the second random challenge value (step 225), and the AES encryption/decryption session key 122 and the HMAC authentication session key 124 for subsequent use, the second microcontroller 70 forms a key acknowledgement and second challenge response frame using the second random challenge value. The key acknowledgement and second challenge response frame is then encrypted and authenticated via the AES/HMAC security function 118 using the AES encryption/decryption system key 65 and the HMAC authentication system key 63. It is further encrypted via the WEP function 108 using the WEP system key 110 to form the encrypted and authenticated key acknowledgement and second challenge response frame, and then transmitted via the wireless transceiver 106 of the PC 54 (step 226).

In addition to forming, authenticating, encrypting and transmitting the key acknowledgement and second challenge response frame, the second microcontroller 70 establishes the virtual serial port to enable subsequent serial relay data to be passed to and from the legacy software applications 114-116 (step 228).

When received by the wireless transceiver 106 of the encrypting/decrypting transceiver 58 (step 230), the encrypted and authenticated key acknowledgement and second challenge response frame is decrypted via the WEP function 108 using the WEP system key 110 and further decrypted and finally authenticated via the AES/HMAC security function 118 using the AES encryption/decryption system key 65 and the HMAC authentication system key 63 (step 232). If the key acknowledgement and second challenge response frame authenticates properly and if the second random challenge value matches the second random challenge value caused to be previously generated by the first microcontroller 64 (step 233), then the microcontroller 64 begins the relay maintenance session using the AES encryption/decryption session key 122 and the HMAC authentication session key 124, thereby enabling relay data originating via legacy software applications to be converted from serial relay data into secure data frames suitable for wireless transmission to the protective device 52, and vice versa, and enabling relay data originating via the relay 56 to be converted from serial data into secure data frames suitable for transmission to the PC 54, and vice versa. (step 234).

Thus, after establishment of the virtual serial port 120 following successful completion of the session authentication dialog, the relay data provided by the relay 56 to the PC 54 is provided to the first microcontroller 64 via the first and second serial ports 60 and 62 using well-known methods (e.g., data terminal equipment (DTE) interface to a universal asynchronous receiver/transmitter (UART) to a complementary data communication equipment (DCE) interface. The relay data is then authenticated and encrypted and transmitted to the PC 54 via the communication link 53. When received by the PC 54, the second microcontroller 70, applying the decryption and authentication methods described above, establishes that the relay data is authentic.

Similarly, after establishment of the virtual serial port 120 following the successful session authentication dialog, the relay data provided via the legacy software applications 114-116 of the PC 54 to the relay 56 is provided to the second microcontroller 70 via the virtual serial port 120. The relay data is then authenticated and encrypted and transmitted to the protective device 52 via the communication link 53. When received by the encrypting/decrypting device 58, the first microcontroller 64, applying the decryption and authentication methods described above, establishes that the relay data is authentic. If authenticated, the relay data is provided to the relay 56 via the second and first serial ports, 62, 60, respectively.

While this invention has been described with reference to certain illustrative aspects, it will be understood that this description shall not be construed in a limiting sense. Rather, various changes and modifications can be made to the illustrative embodiments without departing from the true spirit, central characteristics and scope of the invention, including those combinations of features that are individually disclosed or claimed herein. Furthermore, it will be appreciated that any such changes and modifications will be recognized by those skilled in the art as an equivalent to one or more elements of the following claims, and shall be covered by such claims to the fullest extent permitted by law.

What is claimed is:

1. A system for converting serial data associated with an intelligent electronic device (IED) into secure data packets configured for transmission, the system comprising:
a first intelligent assembly operatively coupled to the IED, the first intelligent assembly including a first I/O module, and a first microcontroller operatively coupled to the first I/O module, the first intelligent assembly adapted to apply at least two independent security algorithms to the serial data to form the secure data packets and to the secure data packets to form the serial data; and
a second intelligent assembly including a plurality of legacy software applications, a second I/O module and a second microcontroller operatively coupled to the second I/O module and the plurality of legacy software applications, the second intelligent assembly adapted to apply the at least two independent security algorithms to the serial data to form the secure data packets and to the secure data packets to form the serial data,
wherein the plurality of legacy software applications are executable by the second microcontroller to enable an IED maintenance session to be conducted by an operator from a location of the second intelligent device upon establishment of a virtual serial port.

2. The system of claim 1, wherein the transmission is wireless via a wireless communication link established between the first and second intelligent assemblies, wherein the first I/O module comprises a first wireless module including a first wireless port, and wherein the second I/O module comprises a second wireless module including a second wireless port.

3. The system of claim 2, wherein each of the first and second wireless modules further comprises:
a wireless transceiver adapted to transmit and receive the secure data packets over the wireless communication link; and
a wired equivalency privacy (WEP) encryption/decryption function including a corresponding WEP encryption/decryption key.

4. The system of claim 2, wherein each of the first and second wireless modules further comprises a wireless transceiver adapted to transmit and receive the secure data packets over the wireless communication link.

5. The system of claim 1, wherein the first intelligent assembly further comprises a random number generator operatively coupled to the first microcontroller.

6. The system of claim 1, wherein the virtual serial port enables serial data exchange between the plurality of legacy software applications and the IED during the IED maintenance session.

7. The system of claim 1, wherein the at least two independent security algorithms comprise an Advance Encryption Standard (AES) encryption/decryption function and a Hashed Message Authentication Code (HMAC) authentication function.

8. The system of claim 1, wherein the second intelligent assembly is selected from the group consisting of a mobile portable computer, a computer terminal, a personal digital assistance and a mobile telephone.

9. The system of claim 1, wherein the IED and the first intelligent assembly are co-located at a first location and the second intelligent assembly is located at a second location.

10. The system of claim 1, wherein the IED comprises a protective relay of a power system.

11. The system of claim 1, wherein the serial data is provided via the IED.

12. The system of claim 1, wherein the serial data is provided via at least one of the plurality of legacy software applications.

13. The system of claim 1, wherein the serial data is selected from the group consisting of IED test data, IED maintenance data, IED operational data and IED settings.

14. A system for converting serial data associated with an intelligent electronic device (IED) into secure data packets configured for wireless transmission during an IED maintenance session, the IED including a first serial port, the system comprising:
(a) an encrypting/decrypting transceiver including:
a second serial port adapted to enable serial data exchange with the first serial port,
a first microcontroller operatively coupled to the second serial port, and
a first wireless module including a first wireless port, the first wireless module operatively coupled to the first microcontroller; and
(b) an intelligent portable device including
a second wireless module including a second wireless port, the second wireless module,
a second microcontroller operatively coupled to the second wireless port/module, and
a plurality of legacy software applications executable by the second microcontroller to enable the IED maintenance session to be conducted by an operator from a location of the intelligent portable device upon establishment of a virtual serial port.

15. The system of claim 14, where each of the first and second microcontrollers is adapted to apply the at least two independent security algorithms to the serial data to form the secure data packets and to the secure data packets to form the serial data.

16. The system of claim 14, wherein each of the first and second wireless modules is adapted enable to wireless transmission and receipt of the secure data packets over the wireless communication link.

17. The system of claim 14, wherein each of the first and second wireless modules further comprise:
a wireless transceiver adapted to transmit and receive the secure data packets over the wireless communication link; and
a wired equivalency privacy (WEP) encryption/decryption function including a corresponding WEP encryption/decryption key.

18. The system of claim 14, wherein each of the first and second wireless modules further comprise a wireless transceiver adapted to transmit and receive the secure data packets over the wireless communication link.

19. The system of claim 14, wherein the encrypting/decrypting transceiver further comprises a random number generator operatively coupled to the first microcontroller.

20. The system of claim 14, wherein the virtual serial port enables serial data exchange between the plurality of legacy software applications and the IED during the IED maintenance session.

21. The system of claim 14, wherein the at least two independent security algorithms comprise an Advance Encryption Standard (AES) encryption/decryption function and a Hashed Message Authentication Code (HMAC) authentication function.

22. The system of claim 21, wherein the virtual serial port is established upon successful completion of a session authentication frame exchange between the encrypting/decrypting transceiver and the intelligent portable device, the session authentication frame exchange including application of the AES encryption/decryption function and a corresponding AES encryption/decryption system key and application of the HMAC authentication function and a corresponding HMAC authentication system key.

23. The system of claim 22, wherein the session authentication frame exchange generates an AES encryption/decryption session key and an HMAC authentication session key for use during the during the IED maintenance session after successful completion of the session authentication frame exchange.

24. The system of claim 14, wherein the IED and the encrypting/decrypting transceiver are co-located at a first location and the intelligent portable device is located at a second location.

25. The system of claim 14, wherein the serial data is provided via the IED.

26. The system of claim 14, wherein the serial data is provided via at least on of the plurality of legacy software applications.

27. The system of claim 14, wherein the IED is selected from the group consisting of a remote terminal unit, a protective relay and a programmable logic controller of a power system.

28. A method for converting serial data associated with an intelligent electronic device (IED) into secure data packets configured for transmission between an encrypting/decrypting transceiver and a portable intelligent device during an IED maintenance session, the encrypting/decrypting transceiver operatively coupled to the IED and including a first microcontroller, the portable intelligent device including a second microcontroller, the method comprising:
establishing a communication link between the encrypting/decrypting transceiver and the portable intelligent device;
executing a session authentication frame exchange between the encrypting/decrypting transceiver and the portable intelligent device to verify the portable intelligent device, the session authentication frame exchange including application of at least two independent security algorithms; and
upon successful execution of the session authentication frame exchange, executing a serial data exchange during the IED maintenance session between a plurality of legacy software applications of the portable intelligent device and the IED, the serial data exchange including application of the at least two independent security algorithms.

29. The method of claim 28, further comprising establishing a virtual serial port upon successful execution of the session authentication frame exchange to enable the serial data exchange.

30. The method of claim 28, wherein the IED maintenance session is conducted by an operator from a location of the intelligent portable device.

31. The method of claim 28, wherein the communication link is a wireless communication link.

32. The method of claim 28, wherein the serial data is selected from the group consisting of IED test data, IED maintenance data, IED operational data and IED settings.

33. The method of claim 28, wherein the at least two independent security algorithms comprise an Advance Encryption Standard (AES) encryption/decryption function and a Hashed Message Authentication Code (HMAC) authentication function.

34. The method of claim 33, further comprising utilizing an AES encryption/decryption system key and an HMAC authentication system key during the session authentication frame exchange.

35. The method of claim 34, further comprising utilizing an AES encryption/decryption session key and an HMAC authentication session key during the IED maintenance session, the AES encryption/decryption session key and the HMAC authentication session key generated during the session authentication frame exchange.

36. The method of claim 35, further comprising executing a wired equivalency privacy (WEP) encryption/decryption function including a corresponding WEP encryption/decryption key during the IED maintenance session.

37. The method of claim 35, wherein executing the session authentication frame comprises:
causing a first series of session authentication frames to be generated, authenticated, encrypted and transmitted; and
receiving, decrypting and authenticating a second series of session authentication frames, each the second series of session authentication frames received in response to one of the first series of session authentication frames.

38. The method of claim 35, wherein executing the session authentication frame exchange comprises:
in response to receipt of a request from the operator to establish the IED maintenance session, generating a first frame;
causing the first frame to be authenticated and encrypted to form an authenticated and encrypted first frame;
causing the authenticated and encrypted first frame to be transmitted to the encrypting/decrypting transceiver via the communication link;
in response to successful decryption and authentication of the authenticated and encrypted first frame, receiving an authenticated and encrypted second frame including a first random challenge value generated by a random number generator operatively coupled to the first microcontroller;
causing the authenticated and encrypted second frame to be decrypted and authenticated to extract the first random challenge value;
in response to successful decryption and authentication of the authenticated and encrypted second frame, generating a third frame including a password entered by the operator and a first random challenge value extracted from the second frame;
causing the third frame to be authenticated and encrypted to form an authenticated and encrypted third frame;
causing the authenticated and encrypted third frame to be transmitted to the encrypting/decrypting transceiver via the communication link;
in response to successful decryption and authentication of the authenticated and encrypted third frame, receiving an authenticated and encrypted fourth frame including a second random challenge value, the AES encryption/decryption session key and the HMAC authentication session key generated by the random number generator;
causing the authenticated and encrypted fourth frame to be decrypted and authenticated to extract the second random challenge value, the AES encryption/decryption session key and the HMAC authentication session key;
in response to successful decryption and authentication of the authenticated and encrypted fourth frame, generating a fifth frame including the second random challenge value extracted from the fourth frame;
causing the fifth frame to be transmitted to the encrypting/decrypting transceiver via the wireless communication link; and
establishing the virtual serial port.

39. The method of claim 35, wherein executing the session authentication frame exchange comprises:
receiving an authenticated and encrypted first frame from the intelligent portable device via the communication link;
in response to successful decryption and authentication of the authenticated and encrypted first frame, generating a second frame including a first random challenge value generated by a random number generator operatively coupled to the first microcontroller;
causing the second frame to be authenticated and encrypted to form an authenticated and encrypted second frame;
causing the authenticated and encrypted second frame to be transmitted to the intelligent portable device via the communication link;
in response to successful decryption and authentication of the authenticated and encrypted second frame, receiving an authenticated and encrypted third frame including a password entered by an operator and a first random challenge value extracted by the second microcontroller from the second frame;
causing the authenticated and encrypted third frame to be decrypted and authenticated to extract the password and the first random challenge value included in the authenticated and encrypted third frame;
if the first random challenge value extracted from the second frame matches the first random value generated by the random number generator and if the password extracted from the third frame matches a stored password, generating a fourth frame including a second generated random challenge value, the AES encryption/decryption session key and the HMAC authentication session key generated by the random number generator;
causing the fourth frame to be authenticated and encrypted to form an authenticated and encrypted fourth frame;
causing the authenticated and encrypted fourth frame to be transmitted to the intelligent portable device via the communication link;
in response to successful decryption and authentication of the authenticated and encrypted fourth frame by the second microcontroller, receiving an authenticated and encrypted fifth frame from the portable intelligent device, the authenticated and encrypted fifth frame including a second random challenge value extracted from the fourth frame; and
verifying that the second random challenge value extracted from the fourth frame matches the second random challenge value generated by the random number generator.

40. The method of claim 28, wherein the intelligent portable device is selected from the group consisting of a mobile portable computer, a computer terminal, a personal digital assistance and a mobile telephone.

41. The method of claim 28, wherein the IED comprises a protective relay of a power system.

42. The system of claim 28, wherein the serial data is provided via the IED.

43. The system of claim 28, wherein the serial data is provided via at least one of the plurality of legacy software applications.

44. A method for converting serial data associated with an intelligent electronic device (IED) into secure data packets configured for wireless transmission between an encrypting/decrypting transceiver and a portable intelligent device during an IED maintenance session, the encrypting/decrypting transceiver operatively coupled to the IED and including a first microcontroller, the portable intelligent device including a second microcontroller, the method comprising:
establishing a wireless communication link between the encrypting/decrypting transceiver and the portable intelligent device;
executing a session authentication frame exchange between the encrypting/decrypting transceiver and the portable intelligent device to verify the portable intelligent device, the session authentication frame exchange including application of an Advance Encryption Standard (AES) encryption/decryption function and a Hashed Message Authentication Code (HMAC) authentication function; and
upon successful execution of the session authentication frame exchange, executing a serial data exchange during the IED maintenance session between a plurality of legacy software applications of the portable intelligent device and the IED, the serial data exchange including application of the AES encryption/decryption function and the HMAC authentication function,

45. The method of claim 44, further comprising utilizing an AES encryption/decryption system key and an HMAC authentication system key during the session authentication frame exchange.

46. The method of claim 45, further comprising utilizing an AES encryption/decryption session key and an HMAC authentication session key during the IED maintenance session, the AES encryption/decryption session key and the HMAC authentication session key generated during the session authentication frame exchange.

47. The method of claim 46, further comprising executing a wired equivalency privacy (WEP) encryption/decryption function including a corresponding WEP encryption/decryption key during the IED maintenance session.

48. The method of claim 44, wherein the IED is selected from the group consisting of a remote terminal unit, a protective relay and a programmable logic controller of a power system.
